(19) United States
(12) Patent Application Publication
(10) Pub. No.: US 2008/0163949 A1
(43) Pub. Date: Jul. 10, 2008

(54) SYSTEM AND METHOD FOR TURBULENT FLOW DRAG REDUCTION

(76) Inventors: Andrew T. DUGGLEBY, Blacksburg, VA (US); Kenneth Ball, Blacksburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 11/747,627

(22) Filed: May 11, 2007

Related U.S. Application Data
(60) Provisional application No. 60/802,161, filed on May 22, 2006.

(51) Int. Cl. F15D 1/02; F15C 3/00

(52) U.S. Cl. 138/39; 137/803

(57) ABSTRACT

The invention provides a system and method for turbulent flow drag reduction using discrete counter-rotating elements disposed adjacent a bounding surface and arranged to effectively disrupt or suppress stream-wise vortices and/or traveling waves thereby reducing turbulence and increasing fluid flow. In embodiments, the counter-rotating elements effectively decouple the interaction between traveling waves and stream-wise vortices. By using discrete counter-rotating elements as disclosed, the energy input to the counter-rotating elements is advantageously less than the energy gained from the flow rate increase. The counter-rotating elements may comprise e.g., counter-rotating strips, counter-rotating disks or a plurality of sequentially activated jets. In addition, the bounding surface may comprise a section or pipe, a substantially planar surface, etc. The counter-rotating elements may be used along a section of a pipe, on a surface of an aircraft wing, in HVAC systems, etc. Examples of fluids include, but are not limited to: water, air, natural gas, oil, etc.

### CROSS-REFERENCE TO RELATED APPLICATIONS

This application relies on the disclosure of and claims the benefit of the filing date of U.S. provisional patent application No. 60/802,161, filed 22 May 2006, the entire disclosure of which is hereby incorporated herein in its entirety.

### BACKGROUND OF THE INVENTION

The present invention relates to a system and method of turbulent flow drag reduction.

### Description of Related Art

Turbulent fluid flows are primarily characterized by chaotic, stochastic property changes and may be readily distinguished from laminar flows based on the dimensionless Reynolds number, Re (where flows with a Re above 2300 are considered turbulent). As fluid flows through e.g., a pipe at very low speeds, the flow remains laminar. However, as the speed increases, at some point a transition is made at the boundary layer from a steady laminar flow to a “chaotic” turbulent flow. Although the causal factors for the laminar-turbulent transition are complex, it is recognized that turbulent flows are associated with vortex systems on various scales. It is also known that stream-wise vortices in turbulent flows induce drag. This is partly because stream-wise vortices formed on a wall may rise into, and slow down, mainstream fluid flow.

Drag may be generally described as the sum of all hydrodynamic or aerodynamic forces in the direction of the fluid flow with respect to an external surface. For example, drag due to aerodynamic forces occurs on many external surfaces such as: aircraft wings, ship hulls, and automobiles and trucks, thereby reducing speed and fuel efficiency. In addition, turbulent flow drag in pipes slows down the flow of fluids such as water, oil, etc., which can be very expensive to pump. In the petroleum industry, for example, the monetary costs due to turbulent flow drag can be significant where pipelines transport oil or gas for millions of miles.

Previous attempts at turbulent drag reduction have focused on oscillating the walls bounding an internal flow, at a certain frequency and amplitude. The first to discover this effect was Jung, Mangiavacchi, and Akhavan in 1992 (“Suppression of Turbulence in Wall-bounded Flows by High-frequency Spanwise Oscillations”, Phys. Fluids A, 4:1605) using a DNS channel code. This drag reduction phenomenon was extended to pipe flow by Quadrio and Sibilla in 1999 using a DNS pipe code with a 2^{nd} order finite-difference radial discretization (“Numerical Simulation of Turbulent Flow in a Pipe Oscillating Around its Axis”, J. Fluid. Mech., 424:217), and Choi et al. in 2002 using DNS with a piecemeal Chebyshev radial discretization (“Drag Reduction by Spanwise Wall Oscillation in Wall-bounded Turbulent Flows”, AIAA J, 40(5):842). In these cases, for a certain oscillation frequency and amplitude, drag reduction of up to 50% and 40% was obtained for the channel and pipe, respectfully, where the drag reduction is defined as

$${D}_{r} ( \% ) = \frac{{τ}_{no} - {τ}_{c}}{{τ}_{no}} \times 100$$

for τₙₒ and τ_{c} being the no oscillation and oscillated case, respectfully.

Although wall oscillation is a proven way of reducing drag, there is no practical way to implement this technique efficiently because the work involved in oscillating the entire wall is more than the energy gained from the drag reduction. Recently, it has been proposed that the onset of turbulence is also influenced by traveling waves moving through the fluid at different speeds. Although traveling waves are not directly visible, their effects and patterns have been observed in conjunction with downstream vortices and streaks. Accordingly, there remains a need for a practical and efficient means for turbulent flow drag reduction that effectively disrupts or suppresses surface stream-wise vortices and/or traveling waves.

### SUMMARY OF THE INVENTION

Instead of oscillating an entire wall or surface, the present invention provides discrete counter-rotating elements disposed adjacent a bounding surface and arranged to effectively disrupt or suppress surface stream-wise vortices and/or traveling waves. By using discrete counter-rotating elements as disclosed, the energy input to the counter-rotating elements is advantageously less than the energy gained from the flow-rate increase. Thus, the discrete counter-rotating elements enable more fluid to go through (e.g., a pipe) for the same pumping pressure, or the same amount of fluid for less pumping pressure. In one aspect, the counter-rotating elements are arranged to effectively disrupt or suppress traveling waves and/or stream-wise vortices, thereby reducing turbulence and increasing fluid flow. In a further aspect, the counter-rotating elements effectively decouple the interaction between traveling waves and stream-wise vortices, thereby reducing turbulence and increasing fluid flow. The counter-rotating elements may be used, for example, along a section of a pipe, on a surface of an aircraft wing, in HVAC systems, etc. Examples of bounded fluids include, but are not limited to: water, air, natural gas, oil, etc. Furthermore, as turbulent flow occurs in a wide variety of environments, the counter-rotating elements may be implemented in a variety of applications and structures, and are thus not meant to be limited by way of this discussion except to the extent they might be as described in the accompanying claims.

According to one embodiment, the counter-rotating elements comprise counter-rotating strips (e.g., disposed around the circumference of a pipe). In another embodiment, the counter-rotating elements may comprise counter-rotating disks (e.g., disposed along a planar surface). In yet a further embodiment, the counter-rotating elements may comprise a plurality of jets disposed tangentially to a surface to allow air, water, etc. to be injected inward at an angle. All of the above counter-rotating elements are arranged to achieve the same underlying principle, namely, to disrupt or suppress surface stream-wise vortices and/or traveling waves thereby reducing turbulent flow drag at the boundary layer.

The counter-rotating elements may be rotated using a conventional motor, actuator, etc., and/or may be propelled by fluid flow. For example, a motor may be disposed adjacent to a section of pipe fitted with a pair of counter-rotating strips and operable to drive the strips in opposite directions. Alternatively or additionally, the counter-rotating elements may comprise e.g., a plurality of angled vanes to be propelled by fluid. Thus, as fluid flows through a pipe, for example, the vanes are engaged and the rotating elements induced to spin in their respective directions. If the counter-rotating elements comprise a plurality of jets disposed along the surface, the jets may be sequentially activated (e.g., by a motor, pump, actuator, etc.) to inject air or liquid through the surface at a desired angle and effectively disrupt or suppress the surface stream-wise vortices and/or traveling waves.

### BRIEF DESCRIPTION OF THE DRAWINGS

FIG. 1 shows a side view of a pair of counter-rotating elements to increase fluid flow bounded by a surface, such as a pipe.

FIG. 2 shows graphical results for increased flow through a pipe using a pair of counter-rotating strips.

### DETAILED DESCRIPTION OF CERTAIN EMBODIMENTS OF THE INVENTION

The present invention will now be described with respect to one or more particular embodiments of the invention. The following detailed description is provided to give the reader a better understanding of certain details of embodiments of the invention depicted in the figures, and is not intended as a limitation on the full scope of the invention, as broadly disclosed and/or claimed herein. In addition, for purposes of this disclosure, it should be understood that, unless otherwise indicated, “a” means one or more.

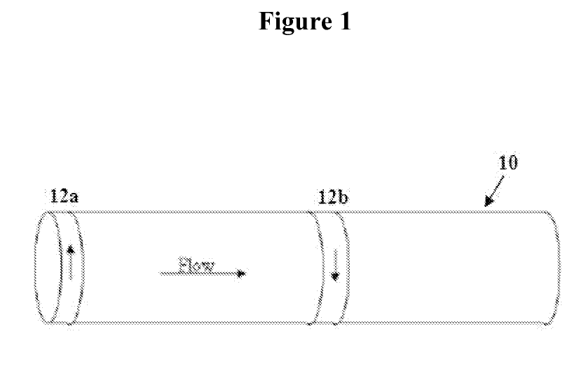

FIG. 1 shows an illustration of discrete counter-rotating elements (12a), (12b), for example counter-rotating strips, disposed adjacent to a bounding surface (10), such as a section of pipe. The counter-rotating elements (12a), (12b) are rotated in opposite directions as shown. As the elements (12a), (12b) are rotated in their respective directions, each generates a small counter-rotating flow effective to disrupt or reduce stream-wise vortices and/or traveling waves that induce drag. For example, the opposite effects of the counter-rotating flows may suppress turbulent-laminar boundary layer separation, prevent vortices from rising into the mainstream fluid flow, etc.

Although only two counter-rotating elements (12a), (12b) are depicted in the figure, it is to be understood that any number of counter-rotating elements (12a), (12b) may be used to reduce effects of turbulence and increase the amount of overall fluid flow over a given distance or area. For example, to increase fluid flow along a pipeline, sections of pipe containing two or more rotating elements may be inserted at various intervals along the line. However, since each counter-rotating element (12a), (12b) induces a small circumferential flow, including a certain amount of associated drag in the direction of rotation, it may be desirable for the counter-rotating elements (12a), (12b) to be designed relatively small and far apart as possible to achieve optimal results. Such design considerations are made so as not to introduce more drag using the counter-rotating elements (12a), (12b) than is experienced in the flow direction. Moreover, retrofitting an existing system (such as inserting pipe sections in a pipeline) may provide additional motivation for spacing the counter-rotating elements (12a), (12b) farther apart in terms of relative cost.

In one non-limiting example, counter-rotating strips may be dimensioned to be one pipe radius in width and 9 radii apart (1 radius spin and 9 radii of no spin) with a spin amplitude on the same order of the flow rate. Physically this is enough to disrupt the stream-wise vortices that form on the wall from rising into and slowing down the mainstream fluid flow. Direct numerical simulation (i.e., no modeling) using the above parameters demonstrated over a 10% increase in overall flow rate. By using a Spectral-Element Navier Stokes solver (NEK5000), results of higher Reynolds number flows (not achievable with prior DNS code) may be observed, thereby allowing optimal design parameters to be obtained.

In a further aspect, the counter-rotating strips may be implemented within a section of pipe using a combination of a spinning liner and ball bearings. In this case, O-rings may additionally be used between pipe sections to prevent leakage. It is understood that the spinning liner may be composed of any material, or possess any property, suited for the particular application. For example, materials that resist rust or corrosion may be desirable in certain underground or saltwater environments.

Besides reducing turbulent flow in pipes, a plurality of rotating disks may be used to achieve turbulent flow drag reduction along substantially planar surfaces as well. In such an embodiment, the counter-rotating elements (12a), (12b) comprise counter-rotating disks disposed e.g., substantially flush with a planar surface. Such rotating disks are useful to increase flow rates for aircraft wings, ship hulls, automobiles and trucks, etc. thereby reducing drag and improving fuel efficiency. Although it is desirable for the elements (12a), (12b) to be relatively as small as possible and spaced as far apart as possible for retrofitting and/or cost purposes, it is to be understood that the relative geometry, size and spacing of such rotating disks depends upon the particular application.

In another embodiment, the counter-rotating elements (12a), (12b) comprise a plurality of jets tangentially disposed along a surface. The jets may be sequentially activated (i.e., rotated) to inject air or liquid through the surface at a particular angle to effectively disrupt the surface stream-wise vortices and/or traveling waves. For example, if the bounding surface is a pipe, a plurality of jets may be disposed circumferentially around a section of the pipe. Alternatively, if the bounding surface is an aircraft wing, jets may be disposed at discrete points along the surface. By sequentially activating one or more of the jets to inject air or fluid through the surface, stream-wise vortices and/or traveling waves may be disrupted or suppressed. Moreover, it is to be understood that since the present invention addresses turbulent flow at the boundary layer, the underlying principles of disrupting stream-wise vortices and/or traveling waves are the same regardless of the counter-rotating elements used and whether the bounding surface is a pipe or a substantially planar surface such as an aircraft wing.

The counter-rotating elements (12a), (12b) may be rotated using a conventional motor (not shown) and/or may be propelled by fluid itself. For example, the motor (not shown) may be disposed adjacent to a section of pipe fitted with a pair of counter-rotating strips and operable to drive the strips in opposite directions. As mentioned, the counter-rotating strips may comprise a spinning liner secured e.g., by ball bearings. Alternatively or additionally, the counter-rotating elements (12a), (12b) may comprise a plurality of angled vanes (not shown) capable of engaging bounded fluid so as to rotate the elements (12a), (12b) in opposite directions. For example, as fluid flows through a pipe, the vanes (not shown) may be engaged and the rotating elements induced to spin in their respective directions. Moreover, as a result of the elements (12a), (12b) being propelled by a fluid, an external power source would not be required thereby even further reducing costs and improving efficiency.

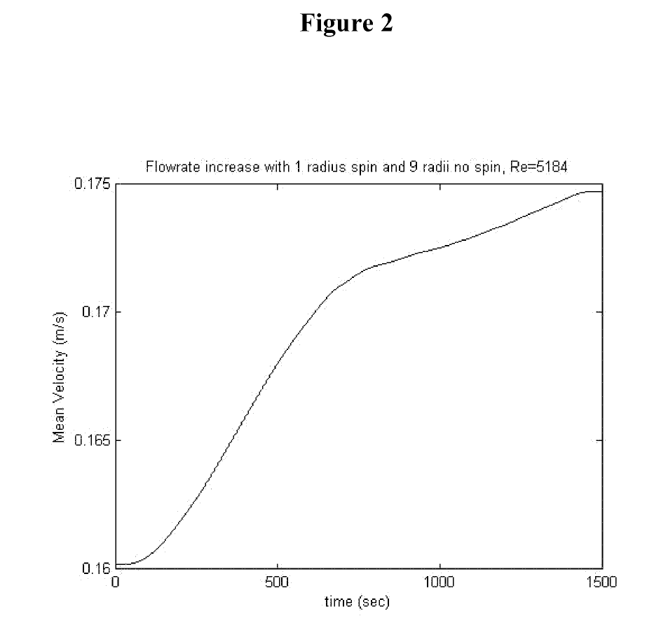

FIG. 2 shows graphical results of the increase in fluid flow through a pipe. The graph shows Flow Velocity versus Time for Re=5184 with a rotation number of 20. According to these parameters, a flow rate increase of up to 10% is achieved. However, it is to be understood that further optimization may be performed for pipes with certain diameters and flow rates such that the flow is completely relaminarized (no turbulence), and obtain approximately a 130% flowrate increase.

While various preferred embodiments have been shown and described, it will be understood that there is no intent to limit the invention by such disclosure. Rather, the disclosure is intended to cover all modifications and alternative constructions falling within the spirit and scope of the invention as defined in the appended claims.

1. A system for turbulent flow drag reduction, comprising:
a surface bounding and/or intercepting fluid flow; and
a plurality of discrete counter-rotating elements disposed adjacent to the surface and arranged to effectively disrupt or suppress stream-wise vortices and/or traveling waves generated within the flow and thereby increase the mainstream fluid flow rate by at least 10%.

2. The system of claim 1, wherein the counter-rotating elements are arranged to effectively decouple interaction between stream-wise vortices and traveling waves.

3. The system of claim 1, wherein each counter-rotating element is arranged to induce a certain amount of flow in the direction of rotation.

4. The system of claim 1, wherein the surface is a section of pipe and the counter-rotating elements comprise counter-rotating strips disposed circumferentially around the pipe.

5. The system of claim 4, wherein the counter-rotating strips further include a plurality of angled vanes that rotate the strips in their respective directions as fluid flows past the vanes.

6. The system of claim 1, wherein the counter-rotating elements comprise a plurality of jets disposed tangentially to the surface.

7. The system of claim 1, wherein the surface is a substantially planar surface and the counter-rotating elements comprise counter-rotating disks disposed substantially flush to the planar surface.

8. The system of claim 1, wherein the mainstream fluid flow rate is increased by at least 50%.

9. The system of claim 1, wherein the mainstream fluid flow rate is increased by at least 75%.

10. The system of claim 1, wherein the mainstream fluid flow rate is increased by at least 100%.

11. A method for turbulent flow drag reduction, said method comprising:
providing a surface that bounds and/or intercepts fluid flow; and
providing a plurality of discrete counter-rotating elements disposed adjacent to the surface and arranged to effectively disrupt or suppress stream-wise vortices and/or traveling waves generated within the flow and thereby increase the mainstream fluid flow rate by at least 10%.

12. The method of claim 11, wherein the counter-rotating elements are arranged to effectively decouple interaction between stream-wise vortices and traveling waves.

13. The method of claim 11, wherein each counter-rotating element is arranged to induce a certain amount of flow in the direction of rotation.

14. The method of claim 11, wherein the surface is a section of pipe and the counter-rotating elements comprise counter-rotating strips disposed circumferentially around the pipe as inserts or integral to the pipe.

15. The method of claim 14, wherein the counter-rotating strips further include a plurality of angled vanes that rotate the strips in their respective directions as fluid flows past the vanes.

16. The method of claim 11, wherein the counter-rotating elements comprise a plurality of jets disposed tangentially to the surface.

17. The method of claim 11, wherein the surface comprises a substantially planar surface and the counter-rotating elements comprise counter-rotating disks disposed substantially flush to the surface.

18. The method of claim 11, wherein the mainstream fluid flow rate is increased by at least 50%.

19. The method of claim 11, wherein the mainstream fluid flow rate is increased by at least 75%.

20. The method of claim 11, wherein the mainstream fluid flow rate is increased by at least 100%.

21. The method of claim 11, wherein the surface comprises a contoured or wavy surface.
